(19) United States
(12) Patent Application Publication
(10) Pub. No.: US 2009/0193664 A1
(43) Pub. Date: Aug. 6, 2009

(54) LOCKING MECHANISM FOR A FOLDING KNIFE

(75) Inventor: Timothy James Galyean, Newberg, OR (US)

Correspondence Address: SEED INTELLECTUAL PROPERTY LAW GROUP PLLC, 701 FIFTH AVE, SUITE 5400, SEATTLE, WA, 98104, US

(73) Assignee: KAI U.S.A., LTD., DBA KERSHAW KNIVES, Tualatin, OR (US)

(21) Appl. No.: 12/363,618

(22) Filed: Jan. 30, 2009

Related U.S. Application Data
(60) Provisional application No. 61/025,732, filed on Feb. 1, 2008.

(51) Int. Cl. B26B 1/04

(52) U.S. Cl. 30/161

(57) ABSTRACT

A locking mechanism for a folding knife includes a first locking element movably coupled to a handle of the knife for movement along a substantially flat recessed bearing surface from an unlocked position to a locked position and a second locking element having a central axis substantially parallel to a pivot axis of the knife, the second locking element biased in a direction substantially along the central axis for movement from an extended position to a depressed position and being adapted to receive a portion of the first locking element to prevent movement of the second locking element to the depressed position and thus inadvertent deployment or closure of the blade when the first locking element is in the locked position.

### CROSS-REFERENCE TO RELATED APPLICATION

This application claims the benefit under 35 U.S.C. § 119(e) of U.S. Provisional Patent Application No. 61/025,732 filed Feb. 1, 2008, the entire disclosure of which is herein incorporated by reference for all purposes.

### BACKGROUND

1. Technical Field

The present disclosure relates generally to a locking mechanism, and particularly to a locking mechanism for an assisted opening or automatic folding knife.

2. Description of the Related Art

Folding knives enjoy wide popularity, particularly among sportsmen, campers, hikers, and many others engaged in outdoor activities. Common elements to folding knives include a handle and a blade pivotally connected to an end of the handle so that the blade pivots with respect to the handle between an open position in which the blade is extended away from the handle, and a closed position in which the blade is at least partially received within the handle. Many folding knives also include a locking mechanism to maintain the blade in the open position and/or the closed position. A locking mechanism is particularly advantageous with folding knives having an assisted opening mechanism and automatic knives (i.e., switchblades).

Examples of folding knives, including folding knives with locking mechanisms, may be found in U.S. Pat. No. 6,338,431, the entire disclosure of which is herein incorporated by reference for all purposes.

One difficulty that has been encountered with folding knives having an assisted opening mechanism and automatic knives in particular, is that a blade of such knives can be unintentionally opened from a closed position by inadvertent activation of an assisted or automatic opening mechanism, and likewise, can suffer from unintentional closure from an open position. Such unintended deployment and closure of the knife blade presents a safety hazard to users, particularly in the case of an automatic knife which can be opened by simply pressing a trigger or firing button.

### BRIEF SUMMARY

According to various embodiments, a locking mechanism for a folding knife effectively prevents unintended movement of a knife blade from a closed or open position.

A locking mechanism for a folding knife may be summarized as including a first locking element slidably coupled to a handle of the knife for movement along a substantially flat recessed bearing surface from an unlocked position to a locked position; and a second locking element having a central axis substantially parallel to a pivot axis of the knife, the second locking element biased in a direction substantially along the central axis for movement from an extended position to a depressed position and being adapted to receive a portion of the first locking element to prevent movement of the second locking element to the depressed position when the first locking element is in the locked position. The first locking element may be slidably coupled to the handle for movement along a first direction substantially perpendicular to the central axis of the second locking element. The first locking element may include an engagement portion adapted to cooperate with the second locking element to prevent movement of the second locking element to the depressed position when the first locking element is in the locked position. The engagement portion of the first locking element may be a notch shaped to partially encircle a reduced diameter neck of the second locking element, the notch including two fingers of sufficient length to extend at least to a central plane through the central axis of the second locking element and perpendicular to the direction of travel of the first locking element when the first locking element is in the locked position. A portion of each of the first locking element and the second locking element may be accessible to a user on a first side of the handle proximate a front end thereof. The first locking element may be bound between the locked position and the unlocked position in part by a raised edge extending from a side of the handle. The locking mechanism may further include a detent mechanism, the detent mechanism configured to resist movement of the first locking element from the locked position towards the unlocked position when the first locking element is in the locked position. The locking mechanism may further include a bias element, the bias element configured to bias the second locking element towards the extended position.

A folding knife may be summarized as including a handle having a pivot axis; a blade coupled to the handle and configured to rotate about the pivot axis between a closed position and an open position; and a locking mechanism coupled to the handle having a first locking element and a second locking element, the first locking element slidably coupled to the handle for movement along a substantially flat recessed bearing surface between a locked position and an unlocked position, the second locking element movably coupled to the handle for movement between an extended position and a depressed position, and the locking mechanism configured to prevent rotation of the blade from the closed position towards the open position when the second locking element is in the extended position and the first locking element is in the locked position. The first locking element may be slidably coupled to the handle for movement in a first direction substantially perpendicular to a central axis of the second locking element. The first locking element may include a notch configured to cooperate with a reduced diameter portion of the second locking element to prevent movement of the second locking element to the depressed position when the first locking element is in the locked position. The first locking element may include engagement means for selectively impeding movement of the second locking element to the depressed position.

The folding knife may further include a detent mechanism, the detent mechanism configured to resist movement of the first locking element from the locked position towards the unlocked position when the first locking element is in the locked position and resist movement of the first locking element from the unlocked position towards the locked position when the first locking element is in the unlocked position. A portion of each of the first locking element and the second locking element may be accessible to a user on a first side of the handle proximate a front end thereof. The second locking element may include a tapered locking surface configured to engage at least one correspondingly tapered notch on the blade, the second locking element positioned to substantially prevent movement of the blade when the tapered locking surface is in contact with the at least one correspondingly tapered notch of the blade. The second locking element may include a reduced diameter portion adapted to cooperate with an engagement portion of the first locking element to prevent movement of the second locking element to the depressed position when the first locking element is in the locked position. The second locking element may include engagement means for coupling with the first locking element to prevent movement of the second locking element to the depressed position when the first locking element is in the locked position. The handle may include a first bias cavity and a second bias cavity, the first bias cavity configured to retain a detent mechanism between the first locking element and the handle, and the second bias cavity configured to retain a spring between the second locking element and the handle. The handle may include a slot configured to limit movement of the first locking element between the unlocked position and the locked position. The handle may include a raised edge surrounding the bearing surface, the raised edge configured to guide the first locking element between the locked position and the unlocked position.

### BRIEF DESCRIPTION OF THE SEVERAL VIEWS OF THE DRAWINGS

FIG. 1 is an isometric view of a folding knife in an open position showing a locking mechanism in a locked position, according to one embodiment.

FIG. 2 is an isometric view of the folding knife of FIG. 1 in a closed position showing the locking mechanism in an unlocked position.

FIG. 3 is a top plan view of the folding knife of FIG. 1 in a closed position showing the locking mechanism in an unlocked position.

FIG. 4 is a front elevational view of the folding knife of FIG. 1 in a closed position showing the locking mechanism in an unlocked position.

FIG. 5 is a front elevational view of the folding knife of FIG. 1 in a closed position with a portion of the handle removed.

FIG. 6A is a rear elevational view of the folding knife of FIG. 1 in a closed position with a portion of the handle and other elements removed.

FIG. 6B is a rear elevational view of the folding knife of FIG. 1 in an open position with a portion of the handle and other elements removed.

FIG. 7A is a cross-sectional top plan view of the folding knife of FIG. 1 taken along line 7-7, with the knife shown in a closed position.

FIG. 7B is an enlarged partial cross-sectional view of the folding knife of FIG. 6A.

FIG. 8A is an isometric view of the folding knife of FIG. 1 in a closed position showing the locking mechanism in a locked position.

FIG. 8B is an isometric view of the folding knife of FIG. 1 in a closed position showing the locking mechanism in an unlocked position.

FIG. 8C is an isometric view of the folding knife of FIG. 1 in a partially deployed position showing the locking mechanism in an unlocked position.

FIG. 8D is an isometric view of the folding knife of FIG. 1 in an open position showing the locking mechanism in an unlocked position.

### DETAILED DESCRIPTION

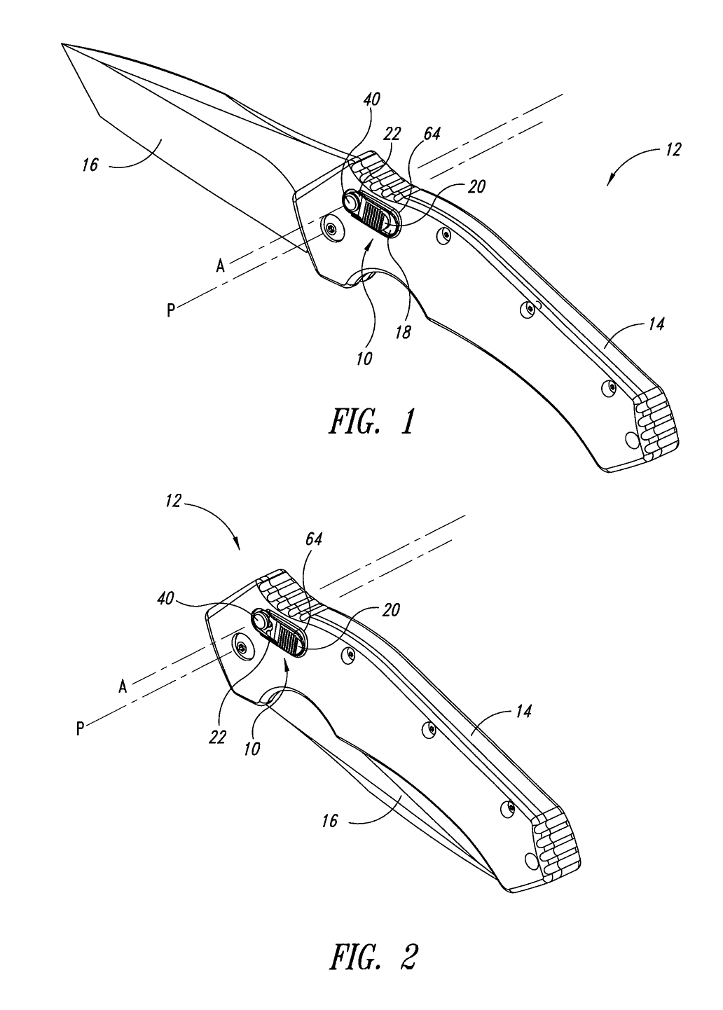

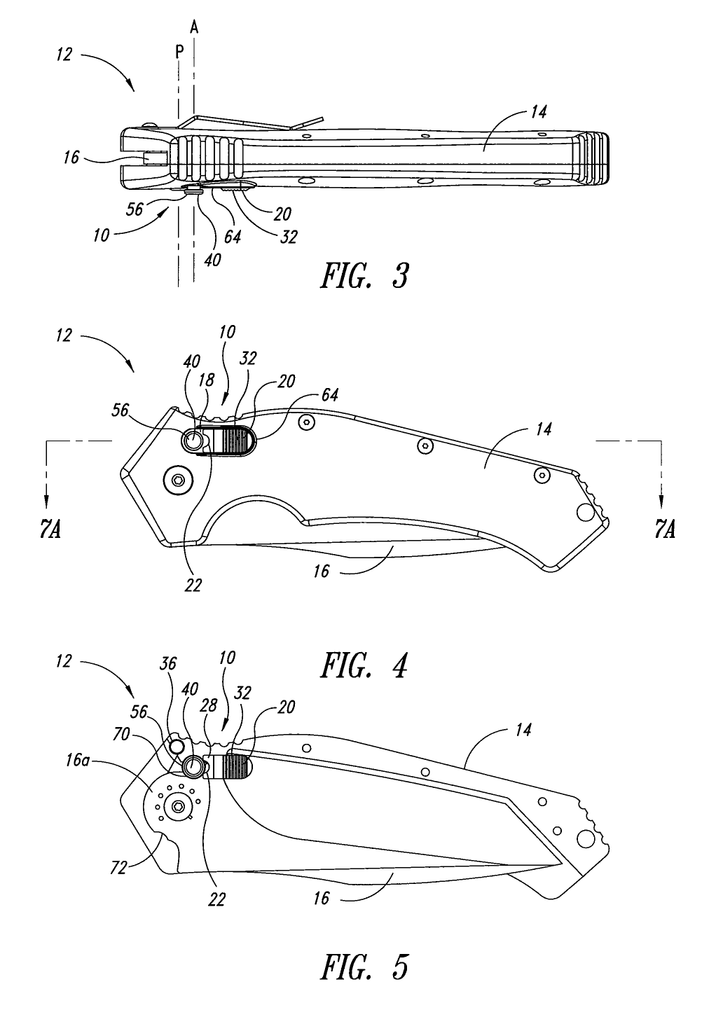

FIGS. 1-8D depict a locking mechanism 10, according to one embodiment, suitable for use with a folding knife 12 having a blade 16 and a handle 14, and particularly suitable for a switchblade or automatic type knife that is spring biased to open quickly. The blade 16 is connected to the handle 14 for pivoting with respect to the handle 14 about a pivot axis P between an open position, as shown in FIG. 1, and a closed position, as shown in FIG. 2.

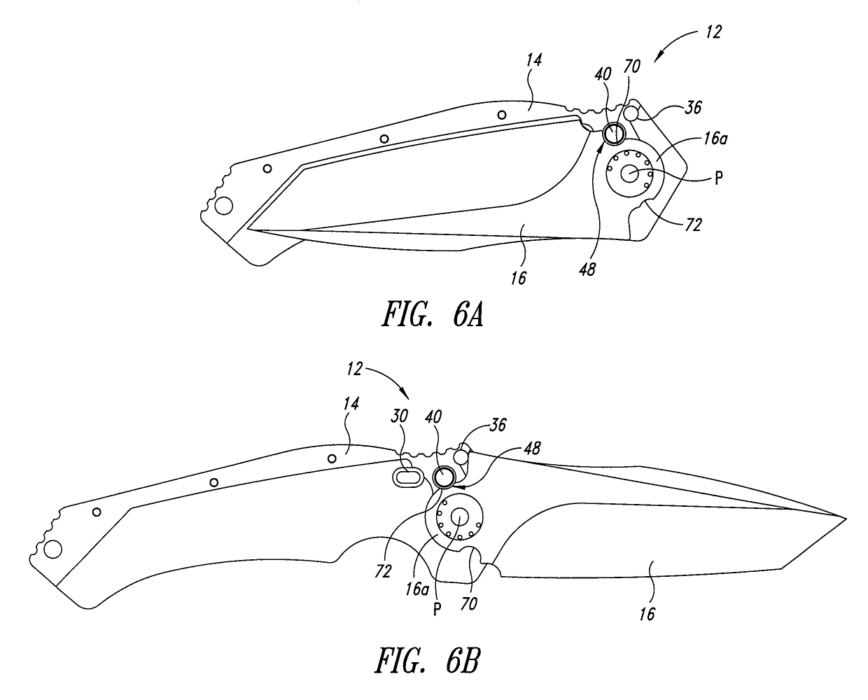

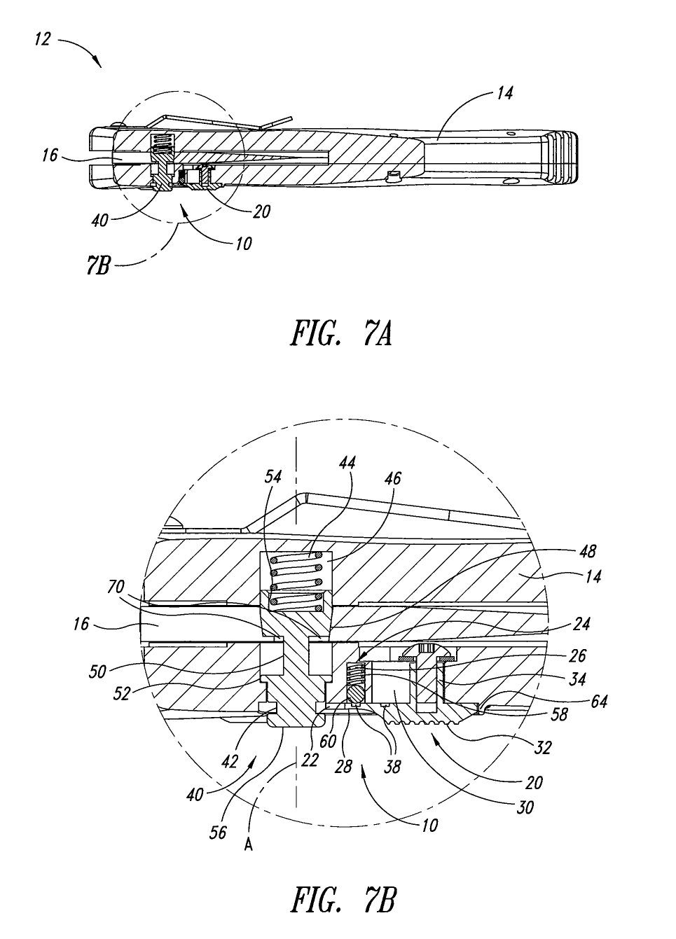

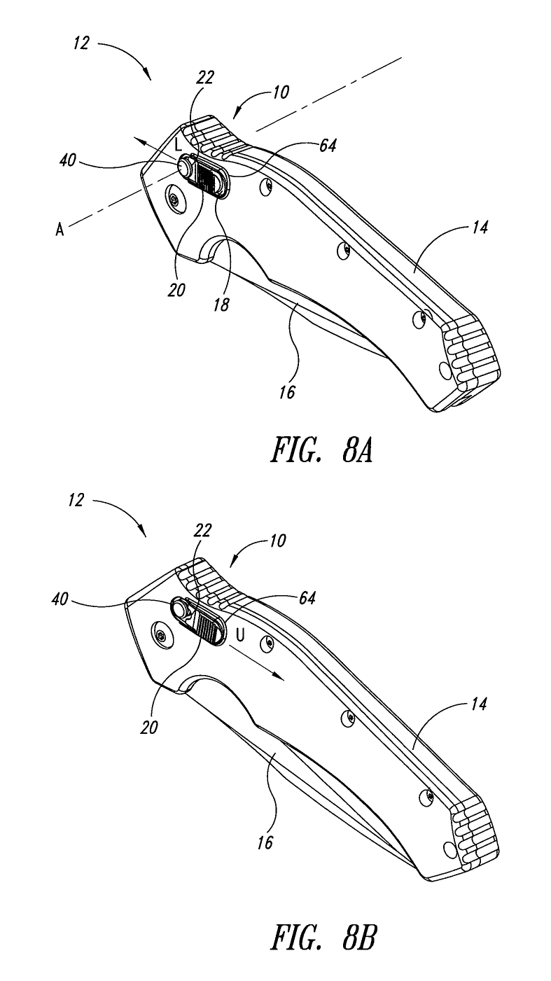

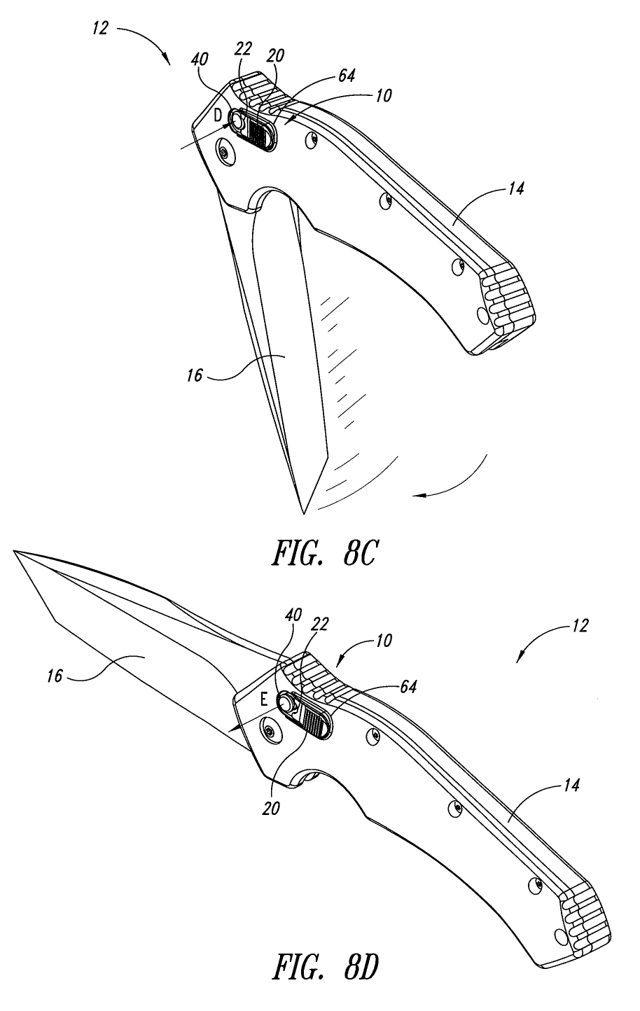

In the open position, the blade 16 extends away from the handle 14, where it is deployed and ready for use. Rotation of the blade 16 toward the open position is limited by contact between a portion of the blade 16 and a contact pin 36 (as shown in FIGS. 5 and 6B) coupled to the handle 14 when the blade 16 is in the fully open position. Alternatively, rotation toward the open position may be limited by a portion of the handle 14 or some other limiting means such as are known in the art. Rotation toward the open position may be assisted or effected by mechanical means, for example, as in an assisted or automatic knife.

From the open position, the blade 16 is folded towards the handle 14, pivoting about pivot axis P, into the closed position. In the closed position, the blade 16 lies in a channel of the handle 14 such that a user is not exposed to the edge of the blade 16. Rotation of the blade 16 toward the closed position may also be limited by any of a variety of methods well known in the art.

The locking mechanism 10, as best shown in FIG. 7B, includes a first locking element 20 and a second locking element 40. The first locking element 20 includes a mounting portion 34, an engagement portion 22, an upper engaging surface 28, a tactile feature 32, and at least one detent 38. The second locking element 40 includes a reduced diameter portion or neck 42, a locking surface 48, reduced diameter body 50, a travel stop 52, a bias chamber 54, and a trigger or button 56.

The first locking element 20 is movably coupled to the handle 14 such that it slides on a substantially flat recessed bearing surface 18 of the handle 14 in a first direction between a locked position L, as shown in FIG. 8A, and an unlocked position U, as shown in FIG. 8B. The bearing surface 18 is offset from an outer surface of the handle 14 to partially conceal the first locking element 20 within an outer contour of the handle 14 and to thereby minimize inadvertent movement of the first locking element 20. The handle 14 further includes a raised edge 64 to assist in maintaining the orientation of the first locking element 20 during use as well as to partially shield the first locking element 20 from inadvertent contact. In this manner, the combination of the recessed bearing surface 18 and raised edge 64 provides a handle structure particularly suited for supporting the first locking element 20 and protecting it from inadvertent movement between the locked position L and unlocked position U.

The first locking element 20 is coupled to the handle 14 by a fastener received by the mounting portion 34 of the first locking element 20. The mounting portion 34 of the illustrated embodiment is configured to ride in a slot 30 located in the handle 14, the slot 30 being configured to limit movement of the first locking element 20 between the unlocked position U and the locked position L. Although the fastener is shown as a screw, other fasteners, such as rivets, pins and other suitable fastening devices that are well known in the art may be used to secure the first locking element 20 to the handle 14.

A first bias element is located in a first bias cavity 26 of the handle 14 to provide an amount of bias between the handle 14 and the first locking element 20. More particularly, as shown best in FIG. 7B, the first bias element comprises a detent mechanism 24 having spring 58 and ball 60, such that ball 60 is biased towards the first locking element 20 for engagement with one or more detents 38 therein. In this manner, to unlock the knife 12, a user is required to apply a manual force sufficient to overcome the holding force applied by the detent mechanism 24 to the first locking element 20. Accordingly, the risk of inadvertent movement of the first locking element 20 is further minimized.

The second locking element 40 is movably coupled to the handle 14 such that it translates partially within the handle 14 along a central axis A between a depressed position D, as shown in FIG. 8C, to an extended position E, as shown in FIG. 8D, the central axis A being substantially parallel to the pivot axis P of the knife 12. A second bias element is located in a second bias cavity 46 of the handle 14 to provide an amount of bias to the second locking element 40. In the illustrated embodiment, the second bias element is a compression spring 44, although it is contemplated that any spring or resilient material can be used. The compression spring 44 is configured to be partially received in a bias chamber 54 of the second locking element 40 to bias the second locking element 40 towards the extended position E. The spring 44 biases the second locking element 40 towards the extended position E such that, when the knife 12 is in the closed position, a locking surface 48 on the second locking element 40 engages a first notch 70 on a tang 16a of the blade 16 to prevent the blade 16 from opening while in the closed position. The first notch 70 is sized to encircle a substantial portion of the second locking element 40, preferably in excess of one-third of the circumference of the second locking element 40 as shown in FIG. 6A. Note various elements have been removed from FIGS. 6A-6B to more clearly show the interaction of the second locking element 40 with the blade 16. To facilitate engagement of the second locking element 40 and the blade 16, the locking surface 48 is tapered. In addition, to facilitate firm contact between the second locking element 40 and blade 16 and maintain contact during wear in, the first notch 70 on the tang 16a may be correspondingly tapered. A travel stop 52 located on the second locking element 40 limits the travel of the second locking element 40 and prevents the second locking element 40 from exiting the handle 14.

The second locking element 40 includes a trigger or button 56 for actuating the second locking element 40 from the extended position E to the depressed position D. To open the knife 12, a user applies a force to the trigger or button 56 of the second locking element 40 to overcome the bias applied by spring 44 and move the second locking element 40 to the depressed position D. When in the depressed position D, a reduced diameter body 50 of the second locking element 40 provides clearance for the blade 16 to freely rotate from the closed position to the open position. Rotation toward the open position may be assisted or effected by mechanical means, such as, for example, a spring coupled between the blade 16 and the handle 14 as is well-known in the art. When the blade 16 of the folding knife 12 is in the open position and the trigger or button 56 is released, the locking surface 48 on the second locking element 40 engages a second notch 72 (as best shown in FIG. 6B) of tang 16a to prevent blade 16 from closing while in the open position. The second notch 72 can engage a relatively less substantial portion of the second locking element 40, for example, about one-quarter of the circumference of the second locking element 40 as shown in FIG. 6B. Again, to facilitate firm contact between the second locking element 40 and the blade 16, the second notch 72 can be tapered to correspond to the taper of the locking surface 48. In this manner, the blade 16 can be conveniently deployed for use and held open in a rigid manner by a simple push and release of a button 56.

To prevent inadvertent deployment of the blade 16, the second locking element 40 is adapted to receive a portion of the first locking element 20 when the first locking element 20 is in the locked position L to prevent movement of the second locking element 40 to the depressed position D. In other words, when the first locking element 20 is moved from the unlocked position U to the locked position L, a portion of the first locking element 20 cooperates with the second locking element 40 to impede movement of the second locking element 40 to the depressed position D. In this manner, the blade 16 is prevented from deploying from the closed position until a user manually moves the first locking element 20 to the unlocked position U. Similarly, when the blade 16 is in the open position and the first locking element 20 is in the locked position L, the first locking element 20 impedes movement of the second locking element 40 and thereby prevents the blade 16 from closing from the open position.

The first locking element 20 includes an engagement portion that is adapted to engage or cooperate with the second locking element 40. More particularly, the first locking element 20 includes a notch portion 22 adapted to engage or cooperate with a reduced diameter portion or neck 42 of the second locking element 40 such that, when the first locking element 20 is in the locked position L, movement of the second locking element 40 to the depressed position D is prevented. The notch portion 22 includes two extending fingers of sufficient length to extend to or past a central plane through the central axis A of the second locking element 40 that is perpendicular to the direction of travel of the first locking element 20 when the first locking element 20 is in the locked position L. According to alternate embodiments, notch portion 22 and reduced diameter portion or neck 42 may be replaced with other suitable engaging features, for example various gripping or clipping means, such that, when the first locking element 20 is in the locked position L, the second locking element 40 is prevented from moving to the depressed position D. For example, the notch portion 22 may be replaced by a blunt edge, stud, or other well-known features for temporary engagement.

In alternate embodiments, the first locking element 20 has an upper engaging surface 28 configured to resist withdrawal from the second locking element 40 when in the locked position L. In some embodiments, the upper engaging surface 28 of the first locking element 20 has a surface treatment or texture for increasing friction. In alternative embodiments, the upper engaging surface 28 may by sloped, bent, comprise detents or have other well-known features for temporary engagement. In still further embodiments, the first locking element 20 and the second locking element 40 overlap slightly to create an interference fit when the first locking element 20 slides to the locked position L.

In some embodiments, the first locking element 20 has a tactile feature 32 to aid a user in transitioning the first locking element 20 between the unlocked position U and the locked position L. In the illustrated embodiment, the tactile feature 32 is a ribbed surface. According to alternate embodiments, tactile feature 32 can be a knurled surface, or any suitable feature capable of providing tactile feedback to a user.

A sequence of operating the locking mechanism 10 is described with reference to FIGS. 8A-8D. A user grasps the knife 12 by the handle 14 and with his or her thumb applies a force to the first locking element 20 to overcome the bias of detent mechanism 24 (not visible) to slide the first locking element 20 towards a front end of the knife 12. The user slides the first locking element 20 in a direction substantially perpendicular to a central axis A of the second locking element 40 (itself substantially parallel to a pivot axis P of the knife 12) until the first locking element 20 reaches a locked position L wherein a portion of the first locking element 20 engages the second locking element 40. When in the locked position L, the second locking element 40 is prevented from being moved to a depressed position D in which the blade 16 is free to rotate. Accordingly, a user is rendered unable to deploy the knife blade 16 until the locking mechanism 10 is unlocked.

When the user desires to deploy the blade 16, the user withdraws the first locking element 20 after first having overcome another bias force applied to the first locking element 20 by the detent mechanism 24. The user returns the first locking element 20 to the unlocked position U shown in FIG. 8B where it is temporarily held in place by the detent mechanism 24. In this unlocked position U, the blade 16 is ready for deployment. To release the blade 16, the user then slightly adjusts his or her thumb to press the second locking element 40 into the side of the handle 14 towards the depressed position D against the force of a compression spring 44 (not visible) retained in the handle 14. The blade 16 is thereafter released from the handle 14 and preferably assisted by mechanical means towards the open position in an automatic fashion as illustrated in FIG. 8C. Because the first locking element 20 and second locking element 40 are in close proximity and located on a common side of the handle 14, a user can unlock the knife 12 and deploy the blade 16 with minimal movement, a feature particularly advantageous in emergency situations.

When the blade 16 reaches the fully open position, the second locking element 40 is automatically urged back towards an extended position E by the compression spring 44 (not visible), as illustrated in FIG. 8D. In the open position, the second locking element 40 moves to the extended position E and reengages the blade 16 thereby holding the blade 16 rigid to the handle 14 so that the knife 12 can be put to use. For additional safety measures, the user can then move the first locking element 20 back to the locked position L thereby preventing the user from inadvertently depressing the second locking element 40 when working with the knife 12. In this manner, the locking mechanism 10 provides a safety device that is particularly suited for use with a switchblade or automatic type knife that is spring biased to open quickly when the second locking element 40 is depressed.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A locking mechanism for a folding knife, comprising:
a first locking element slidably coupled to a handle of the knife for movement along a substantially flat recessed bearing surface from an unlocked position to a locked position; and
a second locking element having a central axis substantially parallel to a pivot axis of the knife, the second locking element biased in a direction substantially along the central axis for movement from an extended position to a depressed position and being adapted to receive a portion of the first locking element to prevent movement of the second locking element to the depressed position when the first locking element is in the locked position.

2. The locking mechanism of claim 1 wherein the first locking element is slidably coupled to the handle for movement along a first direction substantially perpendicular to the central axis of the second locking element.

3. The locking mechanism of claim 1 wherein the first locking element includes an engagement portion adapted to cooperate with the second locking element to prevent movement of the second locking element to the depressed position when the first locking element is in the locked position.

4. The locking mechanism of claim 3 wherein the engagement portion of the first locking element is a notch shaped to partially encircle a reduced diameter neck of the second locking element, the notch including two fingers of sufficient length to extend at least to a central plane through the central axis of the second locking element and perpendicular to the direction of travel of the first locking element when the first locking element is in the locked position.

5. The locking mechanism of claim 1 wherein a portion of each of the first locking element and the second locking element is accessible to a user on a first side of the handle proximate a front end thereof.

6. The locking mechanism of claim 1 wherein the first locking element is bound between the locked position and the unlocked position in part by a raised edge extending from a side of the handle.

7. The locking mechanism of claim 1, further comprising:
a detent mechanism, the detent mechanism configured to resist movement of the first locking element from the locked position towards the unlocked position when the first locking element is in the locked position.

8. The locking mechanism of claim 1, further comprising:
a bias element, the bias element configured to bias the second locking element towards the extended position.

9. A folding knife, comprising:
a handle having a pivot axis;
a blade coupled to the handle and configured to rotate about the pivot axis between a closed position and an open position; and
a locking mechanism coupled to the handle having a first locking element and a second locking element, the first locking element slidably coupled to the handle for movement along a substantially flat recessed bearing surface between a locked position and an unlocked position, the second locking element movably coupled to the handle for movement between an extended position and a depressed position, and the locking mechanism configured to prevent rotation of the blade from the closed position towards the open position when the second locking element is in the extended position and the first locking element is in the locked position.

10. The folding knife of claim 9 wherein the first locking element is slidably coupled to the handle for movement in a first direction substantially perpendicular to a central axis of the second locking element.

11. The folding knife of claim 9 wherein the first locking element includes a notch configured to cooperate with a reduced diameter portion of the second locking element to prevent movement of the second locking element to the depressed position when the first locking element is in the locked position.

12. The folding knife of claim 9 wherein the first locking element includes engagement means for selectively impeding movement of the second locking element to the depressed position.

13. The folding knife of claim 9, further comprising:
a detent mechanism, the detent mechanism configured to resist movement of the first locking element from the locked position towards the unlocked position when the first locking element is in the locked position and resist movement of the first locking element from the unlocked position towards the locked position when the first locking element is in the unlocked position.

14. The folding knife of claim 9 wherein a portion of each of the first locking element and the second locking element is accessible to a user on a first side of the handle proximate a front end thereof.

15. The folding knife of claim 9 wherein the second locking element includes a tapered locking surface configured to engage at least one correspondingly tapered notch on the blade, the second locking element positioned to substantially prevent movement of the blade when the tapered locking surface is in contact with the at least one correspondingly tapered notch of the blade.

16. The folding knife of claim 9 wherein the second locking element includes a reduced diameter portion adapted to cooperate with an engagement portion of the first locking element to prevent movement of the second locking element to the depressed position when the first locking element is in the locked position.

17. The folding knife of claim 9 wherein the second locking element includes engagement means for coupling with the first locking element to prevent movement of the second locking element to the depressed position when the first locking element is in the locked position.

18. The folding knife of claim 9 wherein the handle includes a first bias cavity and a second bias cavity, the first bias cavity configured to retain a detent mechanism between the first locking element and the handle, and the second bias cavity configured to retain a spring between the second locking element and the handle.

19. The folding knife of claim 9 wherein the handle includes a slot configured to limit movement of the first locking element between the unlocked position and the locked position.

20. The folding knife of claim 9 wherein the handle includes a raised edge surrounding the bearing surface, the raised edge configured to guide the first locking element between the locked position and the unlocked position.
